(19) United States
(12) Patent Application Publication
(10) Pub. No.: US 2021/0383473 A1
(43) Pub. Date: Dec. 9, 2021

(54) COMPUTER-READABLE RECORDING MEDIUM STORING TRANSACTION PROGRAM, TRANSACTION METHOD, AND TRANSACTION DEVICE

(71) Applicant: FUJITSU LIMITED, Kawasaki-shi (JP)

(72) Inventors: Toshihiro Shimizu, Kawasaki (JP); Akihito Nakamura, Shinagawa (JP); Motohiro KOSAKI, Kawasaki (JP); Akihiro Kuwabara, Meguro (JP)

(73) Assignee: FUJITSU LIMITED, Kawasaki-shi (JP)

(21) Appl. No.: 17/407,324

(22) Filed: Aug. 20, 2021

Related U.S. Application Data
(63) Continuation of application No. PCT/JP2019/009189, filed on Mar. 7, 2019.

(51) Int. Cl. G06Q 40/04; G06Q 30/02

(52) U.S. Cl. CPC G06Q 40/04; G06Q 30/0282

(57) ABSTRACT

A recording medium stores a transaction program for causing a computer to execute processing including: creating, on the basis of a difference between a selling limit and a next transaction price and a difference between the next transaction price and a buying limit, a dissatisfaction function that represents dissatisfaction of an investor for each contract with the next transaction price as a variable; creating a total dissatisfaction function for all contracts on the basis of the dissatisfaction function created for each contract; specifying, among values of the created total dissatisfaction functions, a value from a predetermined number from a smallest value; and determining the optimum number of contracts on the basis of a plurality of the values from the predetermined number obtained by executing the processing of creating the dissatisfaction function, creating the total dissatisfaction function, and specifying the value from the predetermined number, while changing the number of contracts.

### CROSS-REFERENCE TO RELATED APPLICATION

This application is a continuation application of International Application PCT/JP2019/009189 filed on Mar. 7, 2019 and designated the U.S., the entire contents of which are incorporated herein by reference.

### FIELD

The embodiments discussed herein are related to a transaction program, a transaction method, and a transaction device.

### BACKGROUND

In transactions of stocks or the like, there are Itayose and a continuous session. The Itayose is a transaction in which orders are collected from a time an order is received to a start of trading, and an opening price is determined after the trading is completed. The continuous session is a transaction in which trading is completed between an order already placed and an order newly placed, or between orders newly placed.

Japanese National Publication of International Patent Application No. 2001-522487 and Japanese National Publication of International Patent Application No. 11-504455 are disclosed as related art.

### SUMMARY

According to an aspect of the embodiments, a non-transitory computer-readable recording medium stores a transaction program for causing a computer to execute processing including: creating, on the basis of a difference between a selling limit and a next transaction price and a difference between the next transaction price and a buying limit, a dissatisfaction function that represents dissatisfaction of an investor for each contract with the next transaction price as a variable; creating a total dissatisfaction function for all contracts on the basis of the dissatisfaction function created for each contract; specifying, among values of the created total dissatisfaction functions, a value from a predetermined number from a smallest value; and determining the optimum number of contracts on the basis of a plurality of the values from the predetermined number obtained by executing the processing of creating the dissatisfaction function, creating the total dissatisfaction function, and specifying the value from the predetermined number, while changing the number of contracts.

The object and advantages of the invention will be realized and attained by means of the elements and combinations particularly pointed out in the claims.

It is to be understood that both the foregoing general description and the following detailed description are exemplary and explanatory and are not restrictive of the Invention.

### BRIEF DESCRIPTION OF DRAWINGS

FIG. 1 is a diagram illustrating an example of Itayose by a contract device according to an embodiment;

FIG. 2 is a diagram for describing a definition of dissatisfaction of investors;

FIGS. 3A and 3B are diagrams illustrating examples of an activation function A(d);

FIGS. 4A and 4B are diagrams illustrating examples of a dissatisfaction function DC(q);

FIG. 5 is a diagram illustrating an example of a dissatisfaction summation function;

FIG. 6 is a diagram illustrating change in a minimum value of DCS(q) with respect to change in the number of contracts;

FIG. 7 is a diagram illustrating change in an inclination of the minimum value of DCS(q) with respect to the change in the number of contracts;

FIG. 8 is a diagram Illustrating a configuration of a transaction system according to the embodiment;

FIG. 9 is a flowchart illustrating a flow of processing by the contract device;

FIG. 10 is a flowchart illustrating a flow of processing of specifying a minimum value of the dissatisfaction summation function and the next stock price by using a golden section search;

FIG. 11 is a flowchart illustrating a flow of processing of calculating a value of DS(q);

FIG. 12 is a diagram illustrating a hardware configuration of a computer that executes a contract program according to the embodiment;

FIG. 13 is a diagram illustrating an example of board information in a stock transaction; and

FIG. 14 is a diagram for describing the Itayose in the stock transaction.

### DESCRIPTION OF EMBODIMENTS

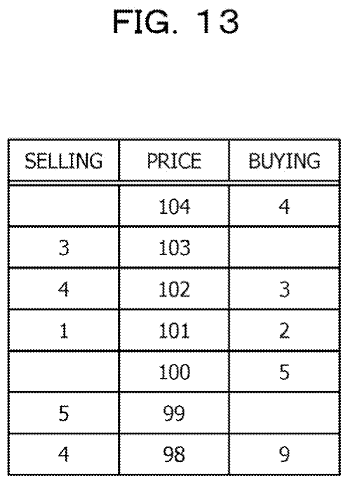

A transaction uses board information indicating a selling limit of a selling order and the number of selling orders and a buying limit of a buying order and the number of buying orders. FIG. 13 is a diagram illustrating an example of board information in a stock transaction. In FIG. 13, a middle column indicates a limit price, a left column indicates the number of selling orders corresponding to the price, and a right column indicates the number of buying orders corresponding to the price. Here, 1 is a unit stock number. For example, the number of selling orders with a selling limit of 102 yen is 4, and the number of buying orders with a buying limit of 102 yen is 3.

In the Itayose in a stock transaction, a contract device contracts selling orders and buying orders in order, in ascending order of a price of the selling order and in descending order of a price of the buying order. Then, the contract device stops the contract when a selling order and a buying order have the same price, and sets the price at this time as a current price. In addition, all the contracted transactions are performed at the current price.

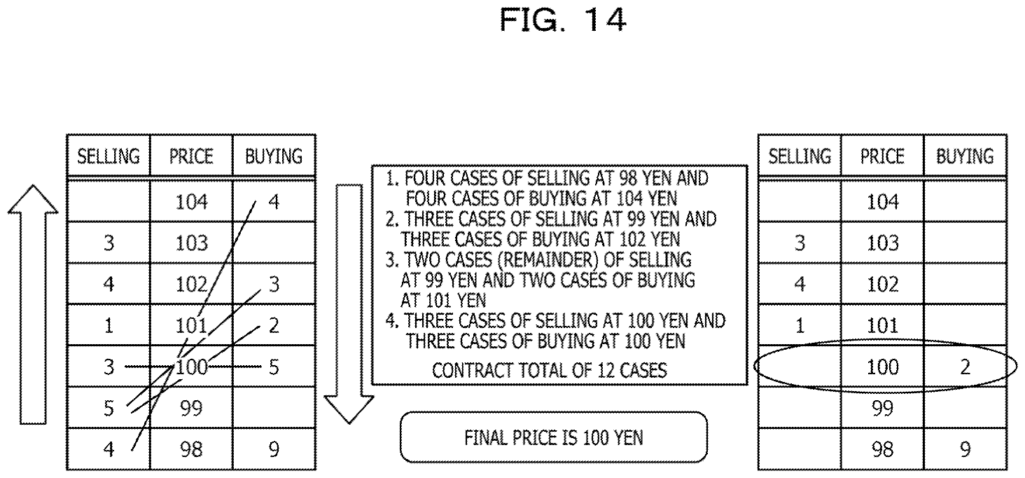

FIG. 14 is a diagram for describing the Itayose in the stock transaction. As illustrated in FIG. 14, the contract device first contracts four cases of selling at 98 yen and four cases of buying at 104 yen. Next, the contract device contracts three cases of selling at 99 yen and three cases of buying at 102 yen. Next, the contract device contracts two cases of selling at 99 yen and two cases of buying at 101 yen. Then, the contract device contracts three cases of selling at 100 yen and three cases of buying at 100 yen, and ends the contract. In this case, the contract device contracts a total of 12 cases for 100 yen, and the current price is set to 100 yen.

Note that, as a prior art, there is a system that performs a linked transaction by a method of optimizing a transaction price for both parties involved in the transaction. Here, the linked transaction is a plurality of securities transactions computerized in individual simultaneous transactions. The system includes a linked transaction workstation, a plurality of transactor workstations, and a central control engine.

A linked transactor uses the linked transaction workstation to input a satisfaction density profile that defines a degree of satisfaction to transact a plurality of securities simultaneously on the basis of an overall cost of the transaction. Individual securities transactors use the transactor workstation to input a satisfaction density profile that indicates a degree of satisfaction to transact specific securities as a function of price/volume.

The central control engine determines a satisfaction density function for each of individual securities on the basis of input of the transactor, and determines a joint satisfaction function for all securities from individual satisfaction density functions. Then, the central control engine determines a mutual satisfaction function from the joint satisfaction function and the satisfaction density profile input by the linked transactor, and maximizes the mutual satisfaction function to establish a set of prices, volumes, and parties for transacting each of the Individual securities. The central control engine further executes simultaneously a transaction among the identified parties for a plurality of securities at the established prices and volumes.

Furthermore, as a prior art, there is a matching system that matches a buying order and a selling order on the basis of a satisfaction density profile that represents a degree of satisfaction to trade an instrument at a plurality of (price, volume) combinations, and outputs price discovery information.

In the Itayose illustrated in FIG. 14, a selling order with a price higher than the current price, a buying order with a price lower than the current price, and either a selling order with the current price or a buying order with the current price are held without being settled. Thus, the held orders remain on a board, and the number of contracts is small. Thus, it is conceivable to increase the number of contracts by making a contract regardless of a current price when a price is more favorable to investors than a limit price. Here, the favorable price is a price higher than the limit price for a selling order and a price lower than the limit price for a buying order.

However, by making a contract regardless of a current price when a price Is more favorable to investors than a limit price, a contract price is different for each contract. Thus, it is needed to decide how to determine the next stock price. Therefore, it is conceivable to quantify dissatisfaction of investors and determine the next stock price so that the dissatisfaction of investors is minimized under the condition of the maximum number of contracts.

However, under the condition of the maximum number of contracts, there is a problem that the dissatisfaction of investors is too great even if the next stock price is determined so as to minimize the dissatisfaction of investors. There is a trade-off relationship between the number of contracts and the dissatisfaction of investors, and when the number of contracts is reduced, the dissatisfaction of investors decreases.

In one aspect, the embodiments discussed herein determine the number of contracts under dissatisfaction acceptable to investors in a case where there is a plurality of contract prices in Itayose.

Hereinafter, embodiments of a transaction program, a transaction method, and a transaction device that are disclosed in the present application will be described in detail with reference to the drawings. Note that the embodiments do not limit the technology disclosed.

### EMBODIMENTS

First, an Itayose method by a contract device according to an embodiment will be described. The contract device according to the embodiment makes a contract regardless of a current price when a price is a limit price or is more favorable to Investors than the limit price.

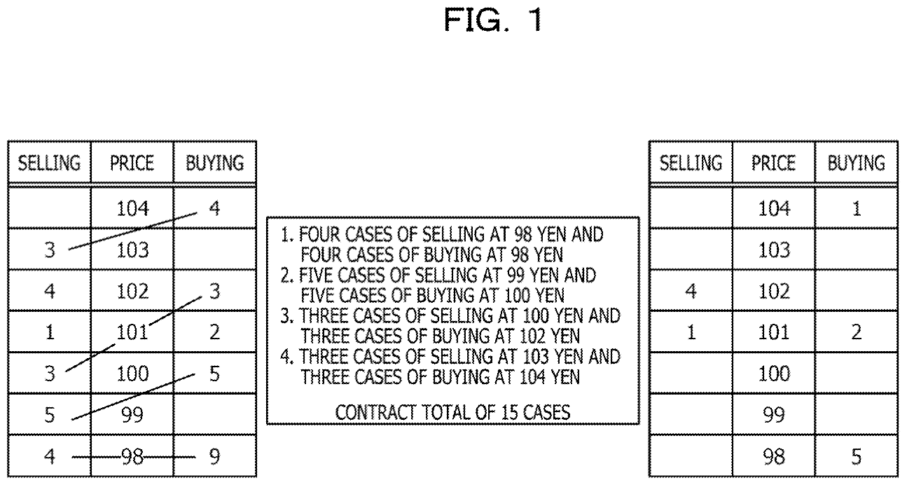

FIG. 1 is a diagram Illustrating an example of Itayose by the contract device according to the embodiment. As illustrated in FIG. 1, the contract device according to the embodiment contracts a total of 15 cases, including four cases of selling at 98 yen and four cases of buying at 98 yen, five cases of selling at 99 yen and five cases of buying at 100 yen, three cases of selling at 100 yen and three cases of buying at 102 yen, and three cases of selling at 103 yen and three cases of buying at 104 yen. Compared with the case illustrated in FIG. 13, in the Itayose method by the contract device according to the embodiment, the number of contracts increases by three cases.

As described above, in the Itayose by the contract device according to the embodiment, since there is a degree of freedom in which selling order and which buying order are to be contracted, it is possible to select a contract method such as maximizing the number of contracts and minimizing a difference in a contract price. Furthermore, in the Itayose by the contract device according to the embodiment, when it is assumed that the next stock price is q yen, the contract price is set to a price close to q yen in a section between a limit price of a seller and a limit price of a buyer.

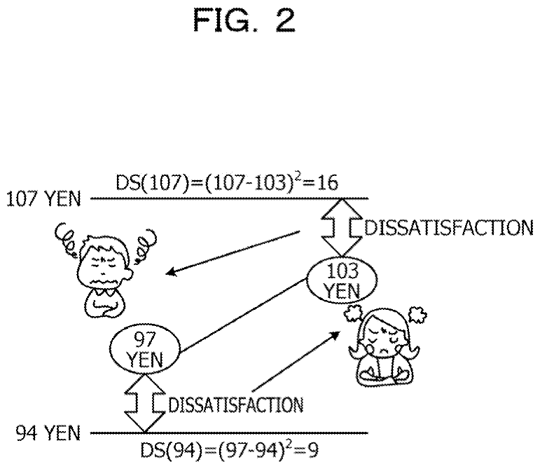

Furthermore, the contract device according to the embodiment quantifies dissatisfaction of investors by using the next stock price, and determines the next stock price as a price that minimizes the dissatisfaction of investors. FIG. 2 is a diagram for describing a definition of the dissatisfaction of investors. In FIG. 2, selling at 97 yen and buying at 103 yen are contracted.

In the case of q<97, a contract price is 97 yen. In this case, a seller is not dissatisfied because a selling price has exceeded a limit price. On the other hand, a buyer is dissatisfied because the next stock price of q yen is lower even though a buying price has been 97 yen. The larger a difference (97−q), the greater the dissatisfaction of the buyer. For example, when the difference² is defined as a dissatisfaction function DC(q), in the case of q=94, DC(94)=(97-94)²=9 is the dissatisfaction of the buyer.

In the case pf 97≤q≤103, since the contract price and the next stock price are equal, neither the seller nor the buyer is dissatisfied.

In the case of 103<q, the contract price is 103 yen. In this case, the seller is dissatisfied because the next stock price of q yen is higher even though a selling price has been 103 yen. The larger a difference (q−103), the greater the dissatisfaction of the seller. On the other hand, the buyer is not dissatisfied because a buying price has been equal to or lower than the limit price. For example, when the difference² is defined as the dissatisfaction function DC(q), in the case of q=107, DC(107)=(107−103)²=16 is the dissatisfaction of the seller.

Thus, the contract device according to the embodiment uses an activation function A(d), which is a function for returning dissatisfaction according to a difference d, a selling limit of s yen, and a buying limit of b yen, to define the dissatisfaction function DC(q) as

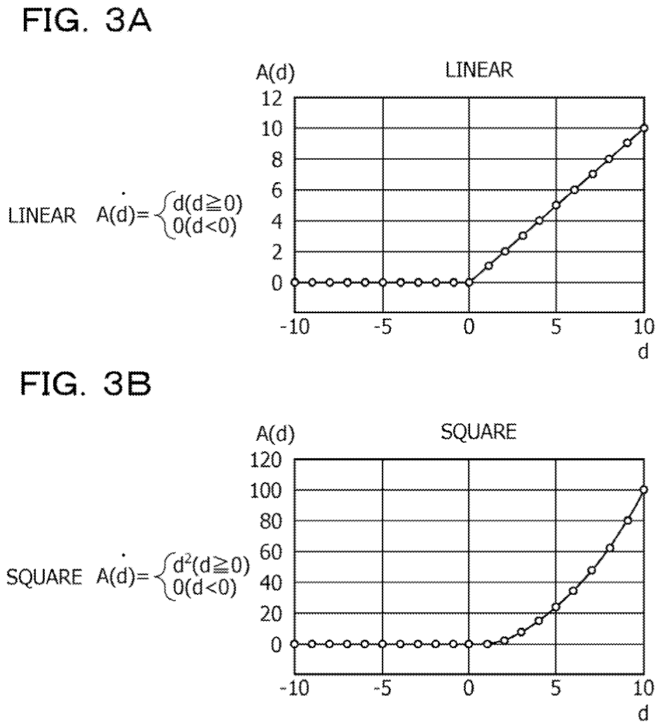

DC(q)=A(s−q)+A (q−b). FIGS. 3A and 3B are diagrams illustrating examples of the activation function A(d). FIG. 3A illustrates a case where the activation function A(d) is linear, and FIG. 3B illustrates a case where the activation function A(d) is square.

As illustrated in FIG. 3A, A(d)=d in the case of d≥0, and A(d)=0 in the case of d<0. Furthermore, as illustrated in FIG. 3B, A(d)=d² in the case ofd□0, and A(d)=0 in the case of d<0.

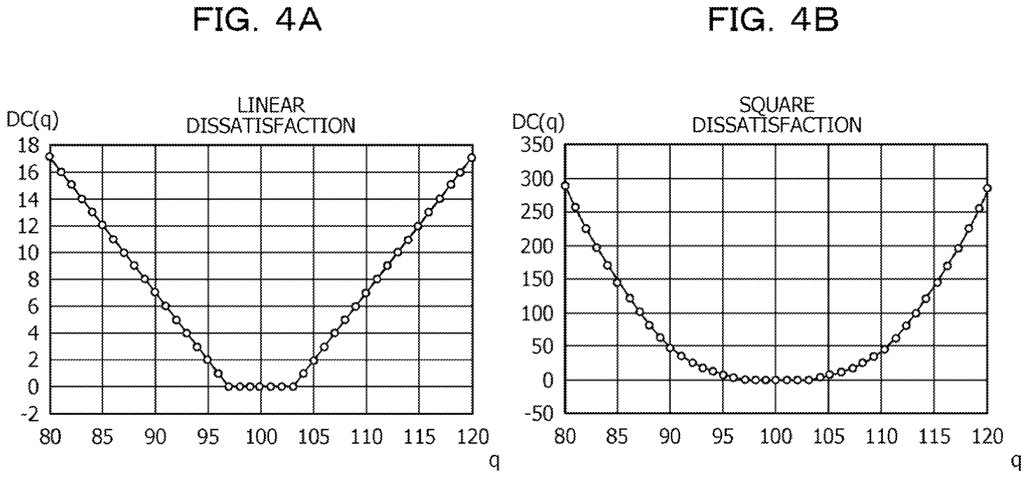

FIGS. 4A and 4B are diagrams illustrating examples of the dissatisfaction function DC(q). In FIGS. 4A and 4B, s=97 and b=103. FIG. 4A illustrates a case where a linear activation function is used, and FIG. 4B illustrates a case where a square activation function is used. As illustrated in FIGS. 4A and 4B, a dissatisfaction function is a convex function that is convex downward.

Then, the contract device according to the embodiment defines a dissatisfaction summation function DCS(q) for the next stock price of q yen as

DCS(q)=ΣDCᵢ(q),

and specifies q that minimizes DCS(q). Here, DCᵢ(q) is the dissatisfaction function in a contract i. DCS(q) is a function that is convex downward.

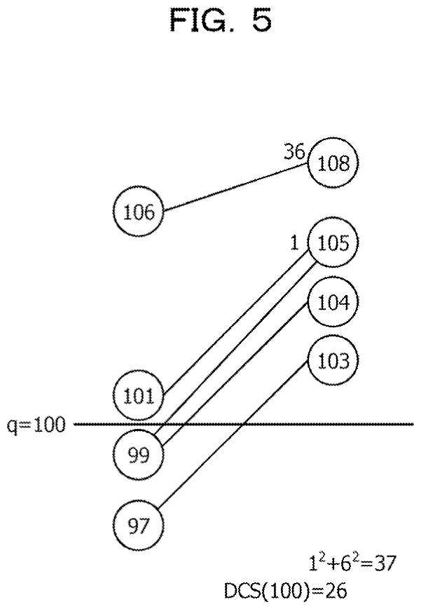

FIG. 5 is a diagram Illustrating an example of the dissatisfaction summation function. As illustrated in FIG. 5, when it is assumed that q=100, a buyer is dissatisfied with two contracts of selling at 101 yen and buying at 105 yen, and selling at 106 yen and buying at 108 yen, and DCS(100)=1²+6²=37. Note that, in this example, a square is used for the activation function A(d).

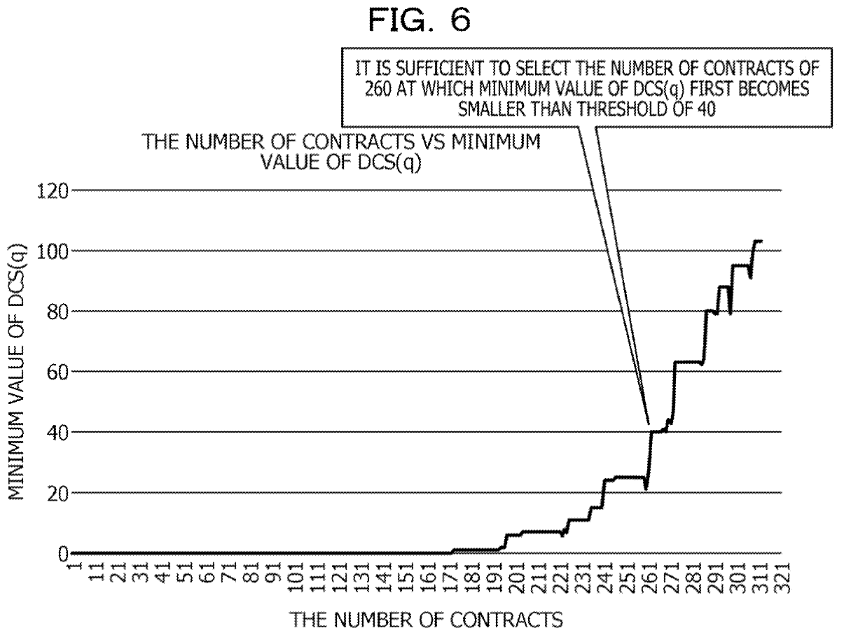

A minimum value of DCS(q) changes depending on the number of contracts. FIG. 6 is a diagram illustrating change in the minimum value of DCS(q) with respect to change in the number of contracts. A horizontal axis is the number of contracts, and a vertical axis is the minimum value of DCS(q). The contract device according to the embodiment sets, for example, a first threshold to 40, reduces the number of contracts from the maximum number of contracts, and determines, as the optimum number of contracts, the number of contracts at which the minimum value of DCS(q) first becomes smaller than the first threshold 40.

As described above, the contract device according to the embodiment defines a limit of dissatisfaction acceptable to investors as the first threshold of the minimum value of DCS(q), and while reducing the number of contracts from the maximum number of contracts, determines, as the optimum number of contracts, the number of contracts at which the minimum value of DCS(q) first becomes smaller than the first threshold. Therefore, the contract device according to the embodiment may determine the optimum number of contracts under the dissatisfaction acceptable to investors.

Note that the contract device according to the embodiment may determine, as the optimum number of contracts, the number of contracts immediately before the minimum value of DCS(q) first exceeds the first threshold, while increasing the number of contracts to the maximum number of contracts.

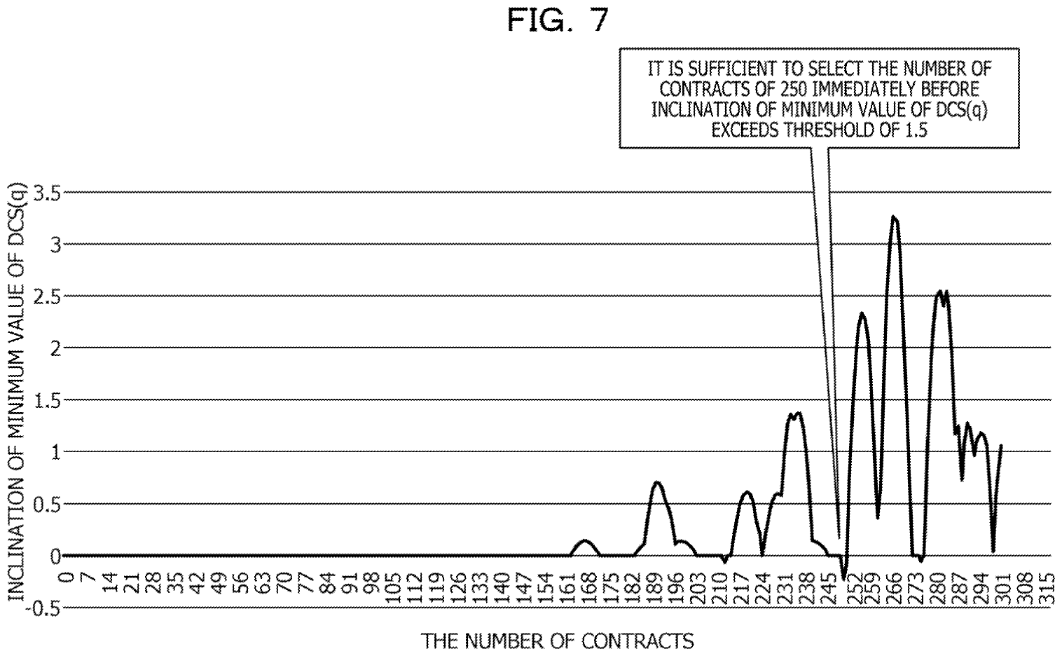

Furthermore, the contract device according to the embodiment may define the limit of the dissatisfaction acceptable to investors as a second threshold of an inclination of the minimum value of DCS(q). FIG. 7 is a diagram illustrating change in the inclination of the minimum value of DCS(q) with respect to the change in the number of contracts. A horizontal axis is the number of contracts, and a vertical axis is the inclination of the minimum value of DCS(q). The contract device according to the embodiment sets, for example, the second threshold to 1.5, increases the number of contracts to the maximum number of contracts, and determines, as the optimum number of contracts, the number of contracts immediately before the inclination of the minimum value of DCS(q) exceeds 1.5.

The contract device according to the embodiment uses, for example, a least squares method for calculating the inclination of the minimum value of DCS(q). When it is assumed that the number of contracts for calculating the inclination and the surrounding number of contracts are x₁, x₂, . . . , xₙ and the corresponding minimum values of DCS(q) are y₁, y₂, . . . , yₙ, the contract device according to the embodiment applies n pieces of data (x₁, y₁), (x₂, y₂), . . . , (xₙ, yₙ) to y=ax+b. The following Equation (1) is used to calculate a and b, and a is the inclination.

$$[ Equation 1 ] \begin{matrix}\begin{matrix}a = \frac{n {\sum }_{i = 1}^{n} {x}_{i} {y}_{i} - {\sum }_{i = 1}^{n} {x}_{i} {\sum }_{i = 1}^{n} {y}_{i}}{n {\sum }_{i = 1}^{n} {{x}_{i}}^{2} - {( {\sum }_{i = 1}^{n} {x}_{i} )}^{2}} & b = \frac{{\sum }_{i = 1}^{n} {{x}_{i}}^{2} {\sum }_{i = 1}^{n} {y}_{i} - {\sum }_{i = 1}^{n} {x}_{i} {y}_{i} {\sum }_{i = 1}^{n} {x}_{i}}{n {\sum }_{i = 1}^{n} {{x}_{i}}^{2} - {( {\sum }_{i = 1}^{n} {x}_{i} )}^{2}}\end{matrix} & ( 1 )\end{matrix}$$

The contract device according to the embodiment selects, for example, ten numbers including u−5, u−4, . . . , u−1, u+1, . . . , u+4, and u+5 as the surrounding number of contracts of the number of contracts u for calculating the inclination.

As described above, by defining the limit of the dissatisfaction acceptable to investors as the second threshold of the inclination of the minimum value of DCS(q), it is possible to determine, as the optimum number of contracts, the number of contracts before the dissatisfaction suddenly increases.

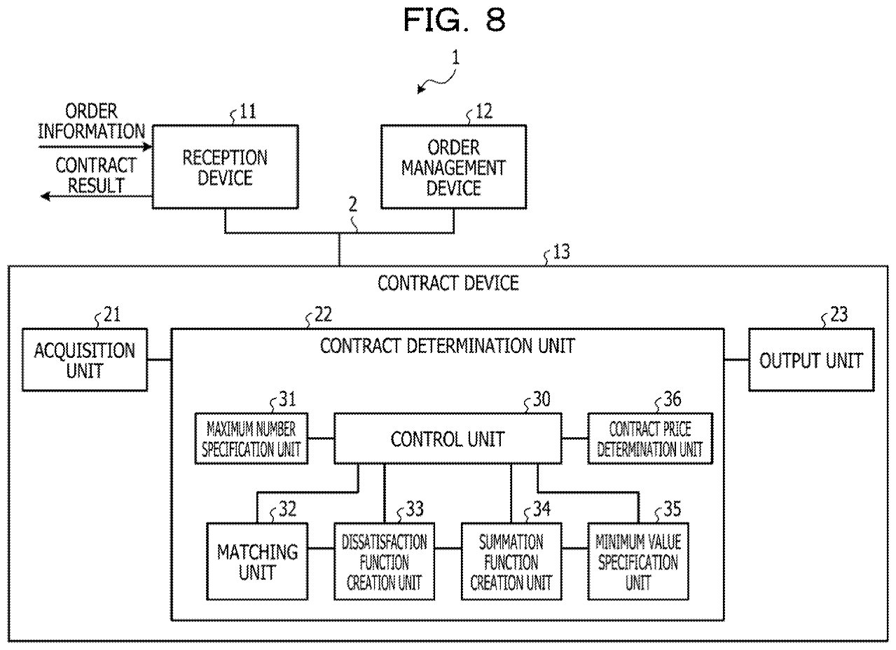

Next, a configuration of a transaction system according to the embodiment will be described. FIG. 8 is a diagram illustrating the configuration of the transaction system according to the embodiment. As illustrated in FIG. 8, a transaction system 1 according to the embodiment includes a reception device 11, an order management device 12, and a contract device 13. The reception device 11, the order management device 12, and the contract device 13 are connected by an internal network 2.

The reception device 11 receives order Information and transmits the order information to the order management device 12. Examples of the order information Include an orderer identifier that Identifies an orderer, a brand, a distinction between buying and selling, a limit price, and the number of stocks. The reception device 11 receives, for example, order information transmitted from an information processing device via an external network. The information processing device transmits the order information on the basis of, for example, an order input by an investor by using a mouse or a keyboard.

Furthermore, the reception device 11 receives a contract result from the order management device 12 and transmits the contract result to the information processing device. Examples of the contract result include an orderer identifier, a brand, a distinction between buying and selling, a contract price, and the number of contract stocks. The reception device 11 transmits the contract result to the information processing device which is a transmission source of the order information, for example, by using an Internet Protocol (IP) address associated with the orderer identifier.

The order management device 12 manages order information by, for example, adding an order identifier that identifies an order. The order management device 12 stores all pieces of order information received by the reception device 11 by a start of the Itayose, and at the start of the Itayose, transmits, for each brand, a selling limit and the number of selling orders, and a buying limit and the number of buying orders to the contract device 13.

Furthermore, the order management device 12 receives, for each brand, contract information from the contract device 13, and updates the order information. Furthermore, the order management device 12 creates a contract result on the basis of the contract information, and transmits the contract result to the reception device 11. Examples of the contract information include, for one or more contracts, a selling limit, a buying limit, a contract price, and the number of contract stocks.

In the Itayose, the contract device 13 receives, for each brand, information regarding a selling order and a buying order from the order management device 12 via the internal network 2, contracts the selling order and the buying order, and determines a contract price and the next stock price. Each piece of the information regarding a selling order includes a selling limit and the number of selling orders, and each piece of the information regarding a buying order includes a buying limit and the number of buying orders. Furthermore, the contract device 13 transmits, for each brand, contract information to the order management device 12 via the internal network 2.

The contract device 13 includes an acquisition unit 21, a contract determination unit 22, and an output unit 23. The acquisition unit 21 receives, for each brand, information regarding a selling order and buying order from the order management device 12 via the internal network 2.

The contract determination unit 22 specifies, for each brand, the maximum number of contracts k, and while reducing the number of matches n by 1 from k, repeats matching of n cases, creation of a dissatisfaction function and a dissatisfaction summation function, and specification of a minimum value of the dissatisfaction summation function and the next stock price, until the minimum value of the dissatisfaction summation function becomes smaller than a first threshold. Then, the contract determination unit 22 sets n when the minimum value of the dissatisfaction summation function becomes smaller than the first threshold as the optimum number of contracts, and passes, for each brand, n, the next stock price, and a selling limit, buying limit, the number of stocks, and contract price for each contract to the output unit 23.

The output unit 23 transmits, for each brand, contract information to the order management device 12 via the internal network 2.

The contract determination unit 22 includes a control unit 30, a maximum number specification unit 31, a matching unit 32, a dissatisfaction function creation unit 33, a summation function creation unit 34, a minimum value specification unit 35, and a contract price determination unit 36.

The control unit 30 controls the maximum number specification unit 31, the matching unit 32, the dissatisfaction function creation unit 33, the summation function creation unit 34, the minimum value specification unit 35, and the contract price determination unit 36 to specify, for each brand, the optimum number of contracts, the next stock price, and a selling limit, buying limit, the number of stocks, and contract price for each contract, and passes them to the output unit 23.

The control unit 30 causes the maximum number specification unit 31 to specify the maximum number of contracts k for each brand. Then, the control unit 30 causes the matching unit 32, the dissatisfaction function creation unit 33, the summation function creation unit 34, and the minimum value specification unit 35 to repeat processing while reducing the number of contracts n by 1 from k, until a minimum value of a dissatisfaction summation function < a first threshold holds, to specify the optimum number of contracts, a contract, and the next stock price. Then, the control unit 30 causes the contract price determination unit 36 to determine a contract price for each specified contract. Then, the control unit 30 passes, for each brand, the optimum number of contracts, the next stock price, and a selling limit, buying limit, the number of stocks, and the contract price for each contract to the output unit 23.

Note that the control unit 30 may set, as the optimum number of contracts, the number of contracts immediately before an inclination of the dissatisfaction summation function first becomes larger than a second threshold. In this case, the control unit 30 calculates the inclination of the dissatisfaction summation function by the least squares method by using a minimum value of a dissatisfaction summation function of the surrounding number of contracts.

The maximum number specification unit 31 specifies, for each brand, the maximum number of contracts on the basis of information regarding a selling order and buying order. The maximum number specification unit 31 specifies the maximum number of contracts k by using, for example, a binary search. For example, in a case where I cases are matched and r (>1) cases are not matched, the maximum number specification unit 31 next determines whether (I+r)/2 cases are matched. Then, the maximum number specification unit 31 next replaces I with (I+r)/2 in a case where (I+r)/2 cases are matched, and replaces r with (I+r)/2 in a case where (1+r)/2 cases are not matched. By repeating such processing until I and r become consecutive numbers, the maximum number specification unit 31 specifies k. Alternatively, the maximum number specification unit 31 may use a bipartite graph to specify the maximum number of contracts k.

The matching unit 32 matches n cases of selling orders and buying orders on the basis of information regarding a selling order and buying order, and a brand and the number of contracts n specified by the control unit 30. The matching unit 32 performs matching regardless of a current price when a price is a limit price or is more favorable to investors than the limit price.

For example, the matching unit 32 may perform matching by randomly selecting a selling order and a buying order. For example, the matching unit 32 creates a list A of j cases of selling orders and a list B of j cases of buying orders. Then, the matching unit 32 selects one combination of the j cases of A and the j cases of B, and performs, for all j cases, recording processing of recording, as a matching candidate, a combination in which a selling limit is equal to or lower than a buying limit. The matching unit 32 executes the recording processing for all combinations while changing the combination of the j cases of A and the j cases of B. Moreover, the matching unit 32 executes the recording processing for all combinations of A and B while changing A or B. Moreover, the matching unit 32 performs the recording processing while changing the number of matches j from 1 to u. Here, u is the smaller one of the number of selling orders and the number of buying orders.

Then, the matching unit 32 selects an optimum matching from the matching candidates. Here, the optimum matching means, for example, an average of selling limits is the lowest, an average of buying limits is the highest, the number of matches is the largest, and there are a few matches between the same securities companies.

Alternatively, the matching unit 32 may perform matching by randomly selecting a selling order and a buying order. For example, the matching unit 32 creates a list A of j cases of selling orders and a list B of j cases of buying orders. Then, the matching unit 32 randomly selects one case from each of A and B to determine a selling limit is equal to or lower than a buying limit, and performs, for all j cases of A and B, recording processing of recording, as a matching candidate, a combination in which the selling limit is equal to or lower than the buying limit. The matching unit 32 executes the recording processing for all combinations of A and B while changing A or B. Moreover, the matching unit 32 performs the recording processing while changing the number of matches j from 1 to u. Then, the matching unit 32 selects an optimum matching from the matching candidates.

Alternatively, the matching unit 32 may perform matching by a branch and bound method. For example, the matching unit 32 performs a depth-first search in matching a selling order and a buying order, and when determining that it is not possible to obtain an optimum matching even when a deeper search is performed at a certain search point, does not perform the deeper search.

Alternatively, the matching unit 32 may use a genetic algorithm to match a selling order and a buying order. For example, the matching unit 32 determines mating rules for two matching plans, mates the two matching plans according to the mating rules, and creates a next-generation matching plan. The matching unit 32 creates a better matching plan by repeating the creation of the next-generation matching plan. The matching unit 32 creates, for example, a matching plan for thousands of generations.

The dissatisfaction function creation unit 33 acquires, for all contracts (matches), a selling limit and buying limit for each contract from the matching unit 32, and creates a dissatisfaction function DC(q) for each contract by using the acquired selling limit and buying limit, the next stock price of q yen, and an activation function A(d).

The summation function creation unit 34 creates a dissatisfaction summation function DCS(q) by adding, for all contracts, a dissatisfaction function DC(q) created for each contract by the dissatisfaction function creation unit 33.

The minimum value specification unit 35 specifies a minimum value of a dissatisfaction summation function DCS(q) and a value qₘᵢₙ of q, which minimizes DCS(q), and sets the next stock price as qₘᵢₙ yen. The minimum value specification unit 35 uses, for example, a golden section search to specify qₘᵢₙ. The minimum value specification unit 35 may use a binary search or a quadrant search to specify rm.

The contract price determination unit 36 determines a contract price for each contract on the basis of a contract specified by the control unit 30. When it is assumed that a selling limit is s yen, a buying limit is b (s≤b) yen, the next stock price is q yen, and a value close to q in a section [s, b] is r, the contract price determination unit 36 sets the contract price to r yen. For example, the contract price determination unit 36 determines the contract price on the basis of the next stock price.

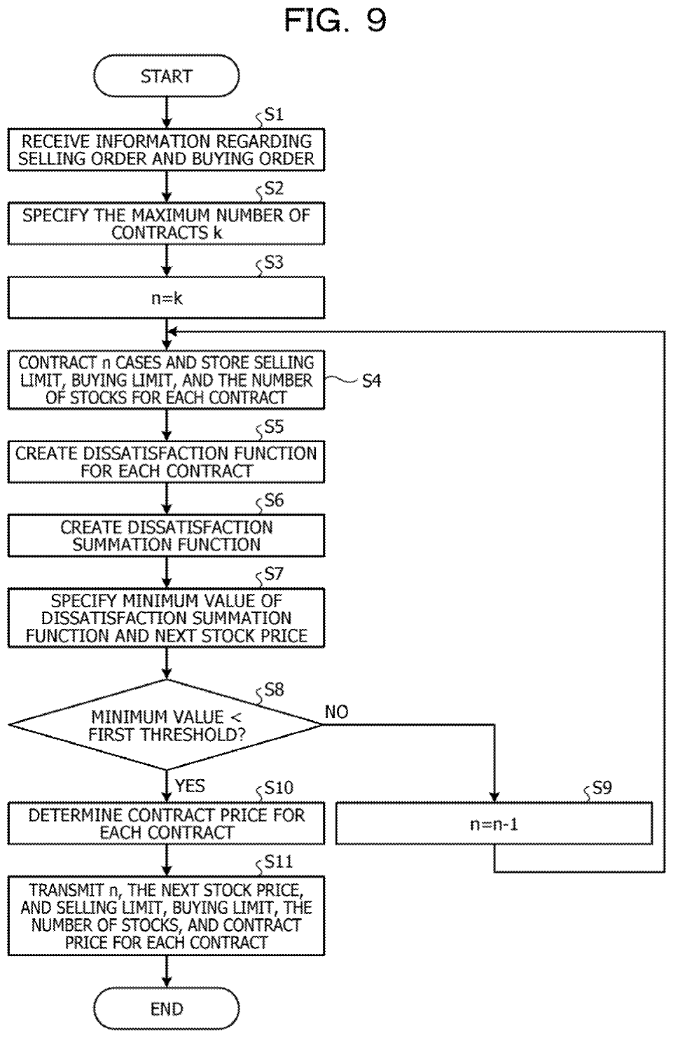

Next, a flow of processing by the contract device 13 will be described. FIG. 9 is a flowchart illustrating the flow of the processing by the contract device 13. Note that the contract device 13 performs the processing illustrated in FIG. 9 for each brand. As illustrated in FIG. 9, at the start of the Itayose, the contract device 13 receives information regarding a selling order and buying order from the order management device 12 (Step S1).

Then, the contract device 13 specifies the maximum number of contracts k (Step S2), and sets an initial value of n to k (Step S3). Then, the contract device 13 contracts n cases on the basis of the information regarding the selling order and buying order, and stores a selling limit, buying limit, and the number of stocks for each contract (Step S4).

Then, the contract device 13 creates a dissatisfaction function for each contract (Step S5), and adds the dissatisfaction functions of all the contracts to create a dissatisfaction summation function (Step S6). Then, the contract device 13 specifies a minimum value of the dissatisfaction summation function and the next stock price (Step S7), and determines whether or not the specified minimum value is smaller than a first threshold (Step S8). Then, in a case where the specified minimum value is not smaller than the first threshold, the contract device 13 subtracts 1 from n (Step S9) and returns to Step S4.

On the other hand, in a case where the specified minimum value is smaller than the first threshold, the contract device 13 determines a contract price for each contract (Step S10), and transmits, to the order management device 12, n, the next stock price, and a selling limit, buying limit, the number of stocks, and the contract price for each contract (Step S11).

As described above, the contract device 13 specifies, while reducing the number of contracts by 1 from the maximum number of contracts k, the number of contracts at which the minimum value of the dissatisfaction summation function first becomes smaller than the first threshold as the optimum number of contracts. Thus, it is possible to specify the number of contracts under dissatisfaction acceptable to investors.

In FIG. 9, in Steps S5 to S7, the dissatisfaction function and the dissatisfaction summation function are created to specify the minimum value of the dissatisfaction summation function and the next stock price. However, the golden section search may be used to directly specify the minimum value of the dissatisfaction summation function and the next stock price. Therefore, processing of directly specifying the minimum value of the dissatisfaction summation function and the next stock price by using the golden section search will be described.

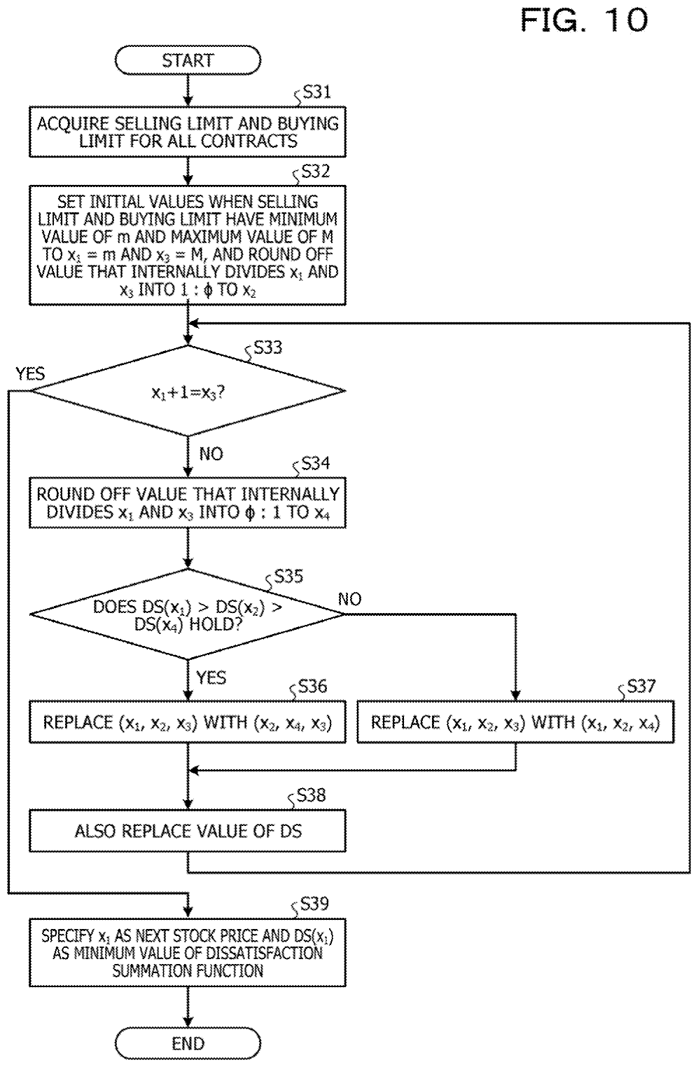

FIG. 10 is a flowchart illustrating a flow of the processing of specifying the minimum value of the dissatisfaction summation function and the next stock price by using the golden section search. As illustrated in FIG. 10, the minimum value specification unit 35 acquires a selling limit and buying limit for all contracts (Step S31). Then, the minimum value specification unit 35 sets initial values when the selling limit and buying limit have a minimum value of m and a maximum value of M to x₁=m and x₃=M, and rounds off a value that internally divides x₁ and x₃ into 1: φ to x₂ (Step S32). Here, φ is a golden ratio ((1+√5)/2).

Then, the minimum value specification unit 35 determines whether or not x₁+1 and x₃ are equal (Step S33), and in a case where x₁+1 and x₃ are not equal, rounds off a value that internally divides x₁ and x₃ into φ: 1 to x₄ (Step S34). Then, the minimum value specification unit 35 determines whether or not DS(x₁)>DS(x₂)>DS(x₄) holds (Step S35), and in a case where DS(x₁)>DS(x₂)>DS(x₄) holds, replaces (x₁, x₂, x₃) with (x₂, x₄, x₃) (Step S36). On the other hand, in a case where DS(x₁)>DS(x₂)>DS(x₄) does not hold, the minimum value specification unit 35 replaces (x₁, x₂, x₃) with (x₁, x₂, x₄) (Step S37). Then, the minimum value specification unit 35 also replaces a value of DS (Step S38), and returns to Step S33.

In Step S33, in a case where x₁+1 and x₃ are equal, the minimum value specification unit 35 specifies x₁ as the next stock price and DS(x₁) as the minimum value of the dissatisfaction summation function (Step S39).

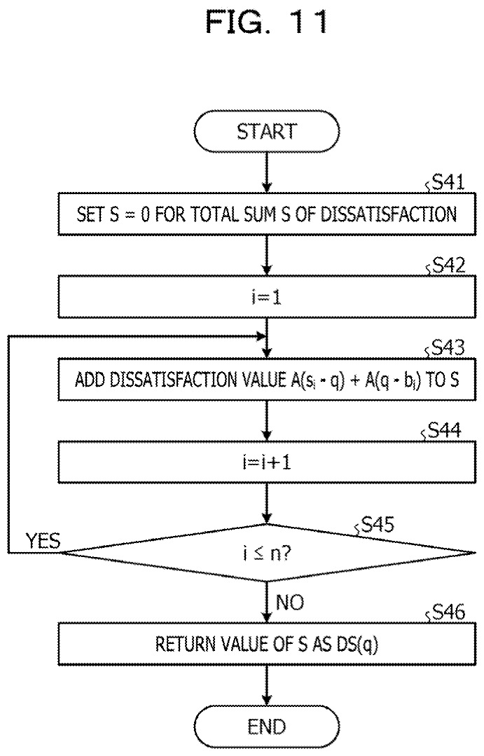

FIG. 11 is a flowchart illustrating a flow of processing of calculating a value of DS(q). As illustrated in FIG. 11, the minimum value specification unit 35 sets S=0 for the total sum S of dissatisfaction (Step S41) and i=1 for a contract i (Step S42). Then, the minimum value specification unit 35 adds a dissatisfaction value A(sᵢ−q)+A(q−bᵢ) of the contract i to S (Step S43), and sets i=i+1 (Step S44).

Then, the minimum value specification unit 35 determines whether or not i is equal to or lower than n (Step S45). Here, n is the number of contracts. Then, the minimum value specification unit 35 returns to Step S43 in a case where I is equal to or lower than n, and returns a value of S as DS(q) in a case where i is not equal to or lower than n (Step S46).

As described above, the minimum value specification unit 35 uses the golden section search to directly specify the next stock price that minimizes the value of the dissatisfaction summation function and the minimum value of the dissatisfaction summation function. Thus, it is possible to efficiently specify the next stock price and the minimum value of the dissatisfaction summation function.

As described above, in the embodiment, the matching unit 32 matches n cases on the basis of information regarding a selling order and a buying order. Then, the dissatisfaction function creation unit 33 creates a dissatisfaction function for each contract on the basis of a difference between a selling limit and the next stock price and a difference between the next stock price and a buying limit. Furthermore, the summation function creation unit 34 creates a dissatisfaction summation function for all contracts on the basis of the dissatisfaction function created for each contract. Then, the minimum value specification unit 35 specifies a minimum value of the dissatisfaction summation function. Then, the control unit 30 causes the matching unit 32, the dissatisfaction function creation unit 33, the summation function creation unit 34, and the minimum value specification unit 35 to repeat processing while reducing n by 1 from the maximum number of contracts k, until the minimum value of the dissatisfaction summation function becomes smaller than a first threshold. Therefore, the contract device 13 may specify the number of contracts under dissatisfaction acceptable to investors.

Note that the minimum value specification unit 35 may specify an i-th value from the minimum value of the dissatisfaction summation function with i as a positive integer. In this case, the control unit 30 causes the matching unit 32, the dissatisfaction function creation unit 33, the summation function creation unit 34, and the minimum value specification unit 35 to repeat processing until the i-th value from the minimum value of the dissatisfaction summation function becomes smaller than the first threshold.

Furthermore, in the embodiment, the control unit 30 may set, as the optimum number of contracts, the number of contracts immediately before an inclination of the minimum value of the dissatisfaction summation function first becomes larger than a second threshold. Furthermore, in the embodiment, the control unit 30 uses the least squares method to calculate the inclination of the minimum value of the dissatisfaction summation function on the basis of a minimum value of a dissatisfaction summation function of the surrounding number of contracts. Thus, it is possible to accurately calculate the inclination of the minimum value of the dissatisfaction summation function.

Note that, in the embodiment, the contract device 13 has been described. However, by implementing the configuration of the contract device 13 by software, it is possible to obtain a contract program that has a similar function. Therefore, a computer that executes the contract program will be described.

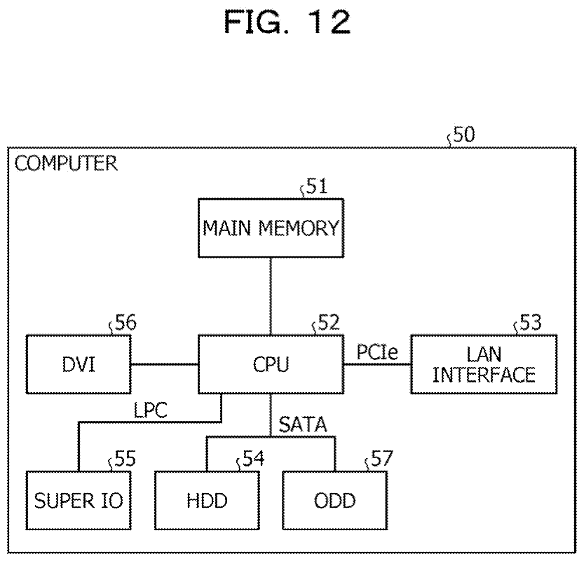

FIG. 12 is a diagram illustrating a hardware configuration of the computer that executes the contract program according to the embodiment. As illustrated in FIG. 12, a computer 50 includes a main memory 51, a central processing unit (CPU) 52, a local area network (LAN) interface 53, and a hard disk drive (HDD) 54. Furthermore, the computer 50 includes a super input output (IO) 55, a digital visual interface (DVI) 56, and an optical disk drive (ODD) 57.

The main memory 51 is a memory that stores a program, a halfway result of execution of the program, and the like. The CPU 52 is a central processing unit that reads a program from the main memory 51 and executes the program. The CPU 52 includes a chipset having a memory controller.

The LAN interface 53 is an interface for connecting the computer 50 to another computer via a LAN. The HDD 54 is a disk device that stores a program and data, and the super IO 55 is an interface for connecting an input device such as a mouse and a keyboard. The DVI 56 is an interface for connecting a liquid crystal display device, and the ODD 57 is a device that reads and writes data from and to a digital versatile disc (DVD).

The LAN interface 53 is connected to the CPU 52 by peripheral component interconnect express (PCIe), and the HDD 54 and the ODD 57 are connected to the CPU 52 by serial advanced technology attachment (SATA). The super IO 55 is connected to the CPU 52 by low pin count (LPC).

Then, the contract program executed by the computer 50 is stored in a DVD that is an example of a recording medium that may be read by the computer 50, and is read from the DVD by the ODD 57 to be installed to the computer 50. Alternatively, the contract program is stored in a database or the like of another computer system connected via the LAN interface 53 and is read from the database or the like and is installed to the computer 50. Then, the installed contract program is stored in the HDD 54, read to the main memory 51, and executed by the CPU 52.

Furthermore, in the embodiment, the case has been described where the transaction system 1 includes the reception device 11, the order management device 12, and the contract device 13. However, the functions of the reception device 11, the order management device 12, and the contract device 13 may be combined into one to constitute a transaction device. Alternatively, optional two functions may be combined into one to constitute one device, such as combining the functions of the reception device 11 and the order management device 12 into one.

Furthermore, in the embodiment, the case of transacting stocks has been described. However, the transaction system 1 may transact other securities and goods.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present Invention have been described in detail, it should be understood that the various changes, substitutions, and alterations could be made hereto without departing from the spirit and scope of the invention.

What is claimed is:

1. A non-transitory computer-readable recording medium storing a transaction program for causing a computer to execute processing comprising:
creating, on the basis of a difference between a selling limit and a next transaction price and a difference between the next transaction price and a buying limit, a dissatisfaction function that represents dissatisfaction of an investor for each contract with the next transaction price as a variable;
creating a total dissatisfaction function for all contracts on the basis of the dissatisfaction function created for each contract;
specifying, among values of the created total dissatisfaction functions, a value from a predetermined number from a smallest value; and
determining the optimum number of contracts on the basis of a plurality of the values from the predetermined number obtained by executing the processing of creating the dissatisfaction function, creating the total dissatisfaction function, and specifying the value from the predetermined number, while changing the number of contracts.

2. The non-transitory computer-readable recording medium storing a transaction program according to claim 1, wherein, in the processing of determining the optimum number of contracts, the optimum number of contracts is determined to be the number of contracts at which the plurality of values from the predetermined number first becomes smaller than a first threshold when the number of contracts is reduced from the maximum number of contracts.

3. The non-transitory computer-readable recording medium storing a transaction program according to claim 1, wherein, in the processing of determining the optimum number of contracts, the optimum number of contracts is determined to be the number of contracts immediately before an inclination of the plurality of values from the predetermined number first exceeds a second threshold when the number of contracts is increased.

4. The non-transitory computer-readable recording medium storing a transaction program according to claim 3, wherein, in the processing of determining the optimum number of contracts, the inclination with respect to the number of contracts is calculated by a least squares method by using the number of contracts smaller than the number of contracts by a fixed number to the number of contracts greater than the number of contracts by the fixed number and the value from the predetermined number that corresponds to each of the number of contracts.

5. The non-transitory computer-readable recording medium storing a transaction program according to claim 1, wherein, in the processing of specifying, a minimum value of the created total dissatisfaction function is specified.

6. The non-transitory computer-readable recording medium storing a transaction program according to claim 5, wherein, in the processing of specifying, a golden section search is used to specify the minimum value of the total dissatisfaction function.

7. A transaction method comprising:
creating, on the basis of a difference between a selling limit and a next transaction price and a difference between the next transaction price and a buying limit, a dissatisfaction function that represents dissatisfaction of an investor for each contract with the next transaction price as a variable;
creating a total dissatisfaction function for all contracts on the basis of the dissatisfaction function created for each contract;
specifying, among values of the created total dissatisfaction functions, a value from a predetermined number from a smallest value; and
determining the optimum number of contracts on the basis of a plurality of the values from the predetermined number obtained by executing a processing of creating the dissatisfaction function, creating the total dissatisfaction function, and specifying the value from the predetermined number, while changing the number of contracts.

8. The transaction method according to claim 7, wherein, in the processing of determining the optimum number of contracts, the optimum number of contracts is determined to be the number of contracts immediately before an inclination of the plurality of values from the predetermined number first exceeds a second threshold when the number of contracts is increased.

9. The transaction method according to claim 7, wherein, in the processing of specifying, a minimum value of the created total dissatisfaction function is specified.

10. An information processing device comprising:
a memory; and
a processor coupled to the memory and configured to:
create, on the basis of a difference between a selling limit and a next transaction price and a difference between the next transaction price and a buying limit, a dissatisfaction function that represents dissatisfaction of an investor for each contract with the next transaction price as a variable;
create a total dissatisfaction function for all contracts on the basis of the dissatisfaction function created for each contract;
specify, among values of the created total dissatisfaction functions, a value from a predetermined number from a smallest value; and
determining the optimum number of contracts on the basis of a plurality of the values from the predetermined number obtained by executing the processing of creating the dissatisfaction function, creating the total dissatisfaction function, and specifying the value from the predetermined number, while changing the number of contracts.

11. The information processing device according to claim 10, wherein, in the processing to determine the optimum number of contracts, the optimum number of contracts is determined to be the number of contracts immediately before an inclination of the plurality of values from the predetermined number first exceeds a second threshold when the number of contracts is increased.

12. The information processing device according to claim 10, wherein, in the processing to specify, a minimum value of the created total dissatisfaction function is specified.
